(19) United States
(12) Patent Application Publication
(10) Pub. No.: US 2026/0195877 A1
(43) Pub. Date: Jul. 9, 2026

(54) HDR FORMAT CONVERSION FOR PROCESSING

(71) Applicant: KONINKLIJKE PHILIPS N.V., EINDHOVEN (NL)

(72) Inventor: Renatus Josephus van der Vleuten, Hamburg (DE)

(21) Appl. No.: 19/542,699

(22) Filed: Feb. 18, 2026

Related U.S. Application Data
(63) Continuation of application No. 19/511,500, filed on Aug. 20, 2024.

(30) Foreign Application Priority Data
Aug. 24, 2023 (EP) 2319135.3

(51) Int. Cl. G06T 5/92; G06V 10/60

(52) U.S. Cl. CPC G06T 5/92; G06V 10/60; G06T 2207/10016; G06T 2207/20208

(57) ABSTRACT

A problem of handling narrow range video signals is handled by a luma mapping apparatus (500), arranged to luma map a video image (IM_IN) comprising pixels of which input lumas (Y_leg) are mainly to be specified in a reduced range (RR) compared to a full range (FR) which full range stretches from zero to a code maximum (CM), which code maximum equals two to the power N, where N is a number of bits for representing the lumas, minus one, which reduced range is delimited by a narrow range lower limit (NR_LL) which is greater than zero, and a narrow range upper limit (NR_UL) which is smaller than the code maximum, wherein some of the input lumas of some of the pixels have values outside the reduced range;
wherein the apparatus comprises a range compressor (102), which maps the lumas to renormalized lumas (Y_norm) comprising mapping the narrow range lower limit (NR_LL) to a processing range lower limit (PR_LL), and mapping the narrow range upper limit (NR_UL) to a processing range upper limit (PR_UL), and mapping all values in between by a linear scaling;
wherein the apparatus comprises a luma mapping circuit (103) arranged to map the renormalized lumas (Y_norm) to remapped lumas (Y_RM) by applying a fixed or configurable luma mapping function to the renormalized lumas;
characterized in that the apparatus comprises a pre-mapper (101) which is arranged to map luma values below a fixed or configurable inflection point (IFP) to values above the inflection point by a mirroring operation, and is arranged to output a sign bit having a first value for pixel lumas that have been mirrored, and a post-mapper (104) which re-mirrors such pixels for which the sign bit equals the first value around the inflection point and corresponding method of video image processing.

### CROSS-REFERENCE TO PRIOR APPLICATIONS

This application is continuation of U.S. application Ser. No. 19/511,580, filed on Feb. 16, 2026 which is the U.S. National Phase application under 35 U.S.C. § 371 of International Application No. PCT/EP2024/073243, filed on Aug. 20, 2024, which claims the benefit of EP Patent Application No. EP 23193135.3, filed on Aug. 24, 2023. These applications are hereby incorporated by reference herein.

### FIELD OF THE INVENTION

The invention relates to luminance-changing color processing for high dynamic range images, in particular relating to narrow range coding.

### BACKGROUND OF THE INVENTION

For more than half a century, creating, communicating and displaying videos (i.e. temporally successive sequences of images) was relatively straightforward. Silver-based movie creation only allowed sending a copy to a limited number of locations. In the first half of the 20^{th} century it became possible to capture an image as an analog voltage signal, transmit that signal over the airways or cable, and ultimately display it on a Cathode Ray Tube display. Around the turn of the century, the analog signal got digitally represented with a 3×8 bit color code per pixel, which yielded the digital video nowadays called Low Dynamic Range (LDR) a.k.a. Standard Dynamic Range (SDR).

The CRT was an uncharacterized display with variable characteristics, but one aspect that was constant is that it had a relatively low range of brightnesses it could display. Although all displays had a somewhat different luminance range, the CRT (on average) would display its brightest color (pure white) at about 100 nit. The darkest black depended on the viewing conditions, and may have been as high as 10 nit, but in ideal dim viewing room conditions it could reach as deep as 0.1 nit.

As FIG. 1 illustrates, although considered pragmatically sufficient for decades, a 1000:1 (at best) dynamic range does not enable true-to-life representation or displaying of the object luminances present in the world. These may vary considerably depending on a daytime scene or a nighttime scene, but even in a single scene they could vary considerably. E.g., the luminances of objects in an indoors environment will depend on the geometry and how much light is present, be it entering through perhaps small windows from the outdoors or as artificial light.

The luminance dynamic range of the scene (RA_SCN) may span object luminances such as 8000 nit for a light bulb 104, 150 nit for a well-lit indoors object 101, and 0.1 nit for an object in the shadows, e.g. a robot vacuum cleaner 102. Objects outdoors in the sun, such as the wall of a house 103, may reach e.g. 3000 nit (on average).

The dynamic range of a variable is the brightest value it has or can have, divided by the smallest value. If one wants to represent every gradation of the scene faithfully, one would need a dynamic range of the representation equal to or greater than the scene dynamic range of this scene, i.e. 80,000:1.

Dynamic range is also often given as an amount of stops (a favorite manner of representation of camera operators), which is the number of times one should double the lowest value (Qm) to arrive at the highest value QM (in other words a log_2 representation). In a linear representation, such as the output of a camera Analog Digital Converter, this would also correspond to the number of bits. But in general one should not confuse the amount of bits used, with the dynamic range, since bit codes can be allocated to relative brightnesses or absolute luminances via highly non-linear Electro-Optical Transfer Functions (in fact, as we have demonstrated in the field, even an 8 bit image coding may represent a High Dynamic Range image as well as an SDR image).

Dynamic range is in electronics technical fields (e.g. sensor technology) often given in decibels, which for linear quantities has the equation:

$$dB = 20 * log\_ 10 ( QM / Qm ) .$$

The human eye has also evolved to “see” a much higher dynamic range than the old cameras could capture, or the old LDR displays could display.

This led to a number of unavoidable artefacts, e.g. the sunlit scene outside the door would be clipped to maximum white, i.e. display as an entirely white rectangle without anything to see. Although our eyes sometimes have some difficulty to adjust to HDR scenes, e.g. dark indoors areas scene from outside, at least everybody knows we can see what is outside the window or door perfectly fine. So there is some unreal aspects to the images. Although one could argue that images are always simply an interpretation of reality, this dynamic range limitation is an aspect that is not necessarily always desirable.

Consequently, the creators of LDR video had to be very careful in how they made their video content, so that it was guaranteed that it looked quite good on all those LDR tv's, even with the lesser dynamic range due to imperfect viewing conditions. When shooting a real world scene, imperfect results could come out. E.g., in the Dutch king's day parade 2023 in Rotterdam, dancers were dancing on a grey and white checkerboard floor. However, even the dark grey squares were so brightly lit by the sun that one couldn't see the difference from the white squares in the LDR video. A few minutes later the director considered it a nice view to shoot musicians from behind to a sunlit background of audience, but everything of the musicians in the shadow under their tent became almost drowned into pure black.

In the era of High Dynamic Range (HDR) video (which is any video with a higher dynamic range than LDR), we can represent all image handling chain scenarios (past with limitations, and current and future), with a simplified dynamic range re-mapping series as in FIG. 1.

Firstly, the luminances of the original objects in the real world don't come into play. This is certainly so if the creator of the video liberally determines the brightnesses of the objects in his video images according to preference, but even when the mapping between the sensor-capturing of the camera and the output image is direct with a simple technical mapping function. One reason is because the camera operator technically controls the exposures of the sensor pixels, i.e. measuring not how much light an object in the world emits, but how much of that light actually enters a sensor pixel. This can be done by such means as an aperture, neutral density filters, etc. How much light actually gets converted into a measurable (digitizable) voltage depends inter alia on the quantum efficiency of the sensor.

The perfect sensor, that has all needed aspects including price, has at present not been developed and produced yet, not even for one application (one may wonder whether a mobile phone in the future would have a similar sensor as a professional camera).

E.g. R. Ikeno et al. in “A 4.6 um, 127-dB Dynamic Range, Ultra-low power stacked digital pixel sensor with overlapped triple quantization”, IEEE Tr. On Electron Devices, vol. 69, no. 6, Jun. 2022, describe a sensor which has a 2 million: 1 (127 dB) capturing dynamic range. However, the sensor has relatively large pixels, and a spatial resolution of only 512×512.

Nevertheless, it is expectable that soon even cheap mobile phones may have sensors able to faithfully capture the colors outside of the door or window, in bright sunlight.

That raises the question on how to display such HDR images, on low dynamic range capability displays. One would need to map (a.k.a. grade) down the brightnesses or luminances of those outside pixels. On a display with a maximum end-user display luminance (ML_D) of 100 nit, one can never render an outdoors which looks much brighter than the indoors pixels. However, one could elect to down-map so that at least something better is shown than all white pixels, e.g. desaturated whitish colors. If however one gets an input signal in which all those pixels have the same value (maximum brightness or luma code 255 e.g.), one can never ever estimate what was outside the door.

Displays indeed started to become better in the first two decades of the 21^{st} century. CRTs had a technical limitation that the light on its front had to be created with an electron beam. Even if it was easy to make a strong electron beam, the electrons tend to repel each other, leading to a thickened beam and reduced spatial resolution. Liquid Crystal Displays initially had one fixed backlight behind the LCD material, e.g. a serpentine or a set of linear TL tubes. This means that although one could brighten the light output of the backlight, the darkest black (i.e. the amount of light LCD pixels leak when being driven with the darkest code, zero) would brighten by the same amount, ergo, the dynamic range would not increase. Patterned a.k.a. 2D dimming backlights put a dedicated LED behind each spatial group of pixels, and then one could brighten the light going through only those pixels in a position on the screen that needed to show a bright object, and even dim the LED in places where a dark area needed to be shown.

This led to a current state of affairs of television sets that can easily show 1000 nit brightest pixels (and some even more, e.g. 2000 nit), and darkest pixels of e.g. 0.01 nit. Professional displays can even go up to 10 k nit.

So now in principle one could capture (or generate in CG) naturalistic images with various HDR effects (e.g. bright and colorful explosions, sunbeams lighting shiny objects, etc.), and one could also display them in an impressive manner for the end user. However, there was one standardized codec in the LDR era, namely the Rec 709, and that was developed to (matchingly) code for the typical best LDR display scenario, i.e. that could code a (relative) brightness range of only 1000:1.

Ergo, in the second decade of the 21^{st} century one needed to develop one or more HDR video coding standards, or one simply could not get the created images to where they needed to be ultimately displayed. An additional design goals to keep in mind was that-although HDR necessitated engineers to look at about each technical aspect known from SDR video handling anew-where possible one would try to stick to compatibility with existing deployed technologies.

FIG. 1 shows in a simplified manner what the camera operator would want to do. The ADC of the camera would typically be aligned with the design of the sensor pixels (e.g. LOFIC, dual conversion gain), but not necessarily with the scene. What is in common with LDR capturing, is that one wants to a have a best basic (RAW) capturing of the scene.

In an LDR system that would be quite difficult. Therefore, the camera operator would typically watch where highlights of a face start becoming too bright (above the ideal ~80% level). On the dark end one would inspect whether at least the important part of the dark scene is sufficiently well visible, and add fill lighting if not. All other objects would have to clip to white or to black (or drown under the noise level NOI). During production, especially broadcast production which is to be aired in real time, one would keep watching scopes, whether the signal indeed stayed (substantially) within the needed levels. In real world scenes, i.e. without controlled lighting, the result could be sub-optimal.

Modern (HDR) cameras typically have 14 stops (16,000:1) camera ADC range (CAM_ADC), with full well digital number MAXFW equaling power(2;14). So, even with this exemplary scene, although one has in general more exposure latitude liberties than with an LDR camera, one may need to be somewhat careful with the exposure. Typically one doesn't need to have all the details (small luminance variations) in the light bulb, so one can expose this so that pixel and ADC overflow and the maximum ADC digital number (DN) is output. In that case there will be still sufficient details in the dark vacuum cleaner, so one can brighten it later in luminance re-grading. The other objects will get a linear percentual (i.e. relative) digital number depending on this setting, i.e. which luminance of the scene (e.g. 7000 nit, or in fact its corresponding pixel exposure F_EXPO) just starts to clip.

From here onwards the approaches to representing (i.e. coding) HDR images diverge. One reason for divergence would be whether one wants to directly code, to record e.g. straight from camera on a memory, or whether one wants to format for some distribution method. But there are other reasons, and in fact there are more types of HDR codec than strictly necessary.

They can be grouped into two categories, the absolute or target display-defined, and the relative, or brightness definition.

To be as professional and future-proof as possible regarding all future uses of the video images (whether in the immediate future for e.g. transcoding, communication and re-grading, e.g. optimizing for a particular display called display adaptation), or a far future, such as long term storage, one wants to relatively precisely define the situation, yet allowing for a lot of variability as the various technical uses may need.

Looking at FIG. 1 the reader can understand that the CAM_ADC definition may mean little, if the relative positions of the values can in later phases be adjusted entirely freely (that might involve a total dis-relationship with the original values, although it is unlikely that one would invert relative brightnesses, to make a first object that originally darker than a second object brighter than the second object in a derived image). Still, one sees that many displays will not have the dynamic range present in the received image, so they need to do something.

In the first 10 years of the 21^{st} century, all input video was SDR, so displays with a higher dynamic range would calculate a pseudo-HDR image (they would e.g. identify light objects in the image, such as the set of pixels forming the sun disk, and then arbitrarily boost the brightness of those relative to the other pixels of the image). For the moment it seems there is more of a trend in various places of the image handling chain to lower or keep low the dynamic range. A number of years from now it is expected that this will stabilize with more insight in the HDR aspects, and some will make lower DR videos, and others will make higher DR videos (i.e. with a higher video maximum luminance ML_C), and there will be displays along a continuum of various maximum end-user display luminance (ML_D). Nowadays a down-grading display could use whatever proprietary algorithm to down-grade the input pixel luminances or brightnesses, but then the content maker still has no idea what the ultimate image will look like. Therefore, to create more consistency in those slippery scales some approaches describe a guidance of how the end display should down-grade the various images (there will be other re-grading needs depending on the scene present in the image, e.g. a dark cave, or an explosion in a daytime scene, so this intended re-grading behavior can be specified by the creator of the video maker by putting the information in metadata, e.g. a SEI message, applicable for each subsequent image of the video).

To this end of more control by the creator regarding how his video should ultimately look to the end viewer, one will first define a target display, which has a color gamut having a target display luminance dynamic range (TARG_DIS). The maximum associated with the video is then the maximum of the target display luminance dynamic range, i.e. ML_C. This allows to content creator to, in a well-determined manner, specify his intended luminances. E.g., since for evening viewing a house of 3000 nit will look too bright, it may be specified with a luminance of 500 nit, still nicely more bright than indoors objects. One can compare this process with the selection of a canvas aspect ratio for optimizing the spatial aspects of a painting. Whereas for a still life one may elect 1:1, for a landscape one may firstly elect that a 3:1 aspect ratio will do better than 1:1. After having set this first technical condition, one can then optimize the composition where to paint which tree and which mountain exactly along that canvas. The same happens when having elected that 5000 nit ML_C will be a good representation of the current movie. One may then optimize the houses outside to have pixel luminances spread around 500 nit, and the bulb perhaps being the maximum, 5000 nit, or lower 3500 nit, etc. Having a target display associated with the images means that one can also make a dark scene to later harmonize with images that have e.g. a 5000 nit sun.

We shall in general in this patent description call the resultant image, whether it has been mapped by a human or some automatic algorithm, the HDR master grading (mast_grad).

To specify how the creator sees the needed re-grading of his primary video of master graded images, he can specify a reference secondary grading. Usually this will not be communicated as an actual secondary image, but one or more functions to map the various luminances that objects can have on the 0 -5000 range, to corresponding luminances on a reference LDR range (RA_REF_LDR), which ranges typically between 0 and 100 nit. Any actual display can then based on the communicated pixelated images (typically YCbCr images, e.g. 10 bit/channel, and an elected EOTF communicated in metadata) and the reference re-grading function calculate a display optimized image (with the object pixel luminances optimally re-positioned along its user display dynamic rang (RA_USR_DIS).

Various codec versions will communicate various graded images to receivers. E.g., one can directly communicate the HDR master grading, but other codecs will communicate the corresponding re-graded reference LDR images. Still other codecs will communicate some intermediate image, having an intermediate dynamic range RA_INT_FRMT, which ends at intermediate maximum luminance ML_IM, e.g. 600 nit.

Lastly, for simplicity of explanation, we have explained everything (currently still only for the absolute nit codecs, nit a.k.a. Cd/m2 being the physical unity of luminance) with the universally understandable luminance ranges and mappings. In practice however images are not coded and communicated directly with luminance values as (one of) their pixel values. Instead some luma code Y represents a luminance, and the EOTF which links all luma codes with corresponding luminances can be elected (e.g. Perceptual Quantizer PQ). So in fact, corresponding to substantially any range of luminances, there corresponds a range of lumas (e.g. the coded luma range for the intermediate format COD_INT_FRMT). In the example shown we elected a typical 10 bit coding, i.e. the luma range spans from 0 to 1023. The maximum luminance of this video corresponds e.g. to a luma=820 (typically the ML_IM is communicated natively in metadata as a number of nits, and the corresponding luma code can be evaluated at a receiving side by co-specifying the EOTF). Note that LDR objects will fall in a small sub-range SR_LDR of the scene luminances, that needed tight covering by LDR cameras, but can be put more liberally inside a larger HDR range for sensor capturing with HDR cameras.

Note also that, whereas we ordered various remappings conceptually, one behind the other in a general typical processing chain, in practice what is done where also depends on the production (some examples of which are illustrated with FIG. 2). E.g., some productions may elect to start from mostly SDR capturings, and make a HDR reference video from all contributions somewhere down the line (e.g., right before broadcasting to end-consumers), and other workflows will make a single HDR master, but will want a derived SDR version for the dominant part of their viewers, which may e.g. be semi-automatically (i.e. an algorithm with some tunable parameters influencing aspects of the automaton's mapping), and run in parallel with the master HDR production, etc. Other systems may convert in in-between relay stations, e.g. a local cable station may mix into the program an upgraded SDR commercial feed (nation-wide commercials may have been produced in HDR, but local commercials may still be in SDR, but need to be broadcasted and displayed in HDR). Especially in those systems where one elects a fixed mapping function (i.e. the same function for all successive images of a program, rather than a function whose shape can be optimized per image), artistic grading choices regarding e.g. the visibility of the blacks may be initially performed (i.e. viewed on a reference monitor) in the SDR domain, but then ripple through as corresponding choices on the HDR master, or both HDR and SDR gradings may be more disjunct.

There is a second class of HDR codings which works paradigmatically differently. The Hybrid Log-gamma coding developed by the British Broadcasting Corporation and standardized in ARIB STD-B67 doesn't specify everything so neatly, and doesn't work with absolute luminance values. In their philosophy one just makes relative brightnesses. To create a larger allocatable range for the video objects, this relative range doesn't end at 100% (white) like in SDR, but goes to 1000%. But a HLG range (RA_HLG) relative maximum being 1000%, of what luminance exactly was not specified or assumed to be specified by the BBC, until they started thinking about conversion of absolute codec material, such as from Blu-ray movies. One can then agree the 1000% level is supposed to correspond to 1000 nit. Also, at the display side any display was normally not to display the 1000% as any specific luminance, but was to display it as its maximum capability (so 1500 nit for a 1500 nit ML_D display, and 550 nit for a 550 nit ML_D display). That creates quite differently looking images, but one could justify this by the effort of buying a more expensive 1500 nit HDR display. However, to make the darker colors look sufficiently contrasty (otherwise the eye will adjust away much of the higher dynamic range look), displays should display HLG signals by applying a gamma correction which increases with larger values of their ML_D value.

So the rightmost dynamic range of FIG. 1 (RA_REF_LDR) is the range of the SDR image. All the other ranges are from HDR images. The SDR image was well-known to the video expert (how to make it, code it, use it, display it, etc.). In terms of brightnesses, it ends (with the brightest color it represents) at Lambertian reflecting white (i.e. white that divides the incoming light equally to all directions, for simplicity one can think of a piece of white paper), under one uniform amount of illumination. If one wants to associate a luminance to this 100% level, it is the typical display luminance of white on a LDR display: 100 nit. HDR images are defined compared to SDR image, in that they have a larger dynamic range (of brightnesses or luminances) than the SDR image range. Although there may also be deeper blacks, in the video technical area one always desires (at least) brighter pixels. Ergo, when taking the black level (darkest black) of a typical living room viewing to be 0.1 nit, the larger range corresponds to a higher percentual brightness (e.g. 1000% being 10× more than the 100% of Lambertian white), or a larger maximum luminance (e.g. ML_C=800 nit). This HDR image definition allows the creation of extra-bright image objects, e.g. one can define white objects which are illuminated by a larger illumination than the average scene illumination, or objects which reflect specularly, or self-luminous objects.

In HDR technology it is usually not merely about how much nit precisely some e.g. maximum luminance should be (i.e. at least not up to e.g. 5 numbers after the decimal point, remembering also that a 2% difference is not noticeable to human viewers), but that for a HDR signal brightnesses of at least some image objects will be substantially higher, e.g. at least 2× higher than 100% respectively 100 nit. In the real world a specular reflection may be thousands of times larger than a diffuse reflection luminance, but in an image representation one may suffice with 10× larger luminance (the goal is to give the viewer some impression of significantly larger brightness, not give him spots in the eye due to bleaching of all his conopsin molecules like in the real world, and one should mind technical limitations such as reasonable power usage). There can be minor corrections on these basic principles when talking about distribution containers, e.g. for a television broadcast or video cable signal (e.g. Serial Digital Interface), but those details will be discussed only to the extent relevant for any embodiment.

Not only did we get more kinds of displays (LCD tv, mobile phone, home cinema projector, professional movie theatre digital projector), and more video sources and communication media (satellite, streaming over the internet, e.g. OTT, streaming over 5G), but also did we get more production manners of video.

FIG. 2 shows—in general, without desiring to be limiting—a few typical creations of video where the present teachings may be usefully deployed.

In a studio environment, e.g. for the news or a comedy, there may still be a tightly controlled shooting environment (although HDR allows relaxation of this, and shooting in real environments). There will be controlled lighting (202), e.g. a battery of base lights on the ceiling, and various spot lights. There will be a number of bulky relatively stationary television cameras (201). Variations on this often real-time broadcast will be e.g. a sports show like soccer, which will have various types of cameras like near-the-goal cameras for a local view, overview cameras, drones, etc.

There will be some production environment 203, in which the various feeds from the cameras can be selected to become the final feed, and various (typically simple, but potentially more complex) grading decisions can be taken. In the past this often happened in e.g. a production truck, which had many displays and various operators, but with internet-based workflows, where the raw feeds can travel via some network, the final composition may happen at the premises of the broadcaster. Finally, when simplifying the production for this elucidation, some coding and formatting for broadcast distribution to end (or intermediate, such as local cable stations) customers will happen in formatter 204. This will typically do the conversion to e.g. PQ YCbCr from the luminances as graded as explained with FIG. 1, for e.g. an intermediate dynamic range format, calculate and format all the needed metadata, convert to some broadcasting format like DVB or ATSC, packetize in chunks for distribution, etc. (the etc. indicating there may be tables added for signaling available content, sub-titling, encryption, but at least some of that will be of lesser interest to understand the details of the present technical innovations).

In the example the video (a television broadcast in the example) is communicated via a television satellite 250 to a satellite dish and a satellite signal capable set-top-box 261. Finally it will be displayed on an end-user display 263.

This display may be showing this first video, but it may also show other video feed, potentially even at the same time, e.g. in Picture-in-Picture windows (or some data of the first HDR video program may come via some distribution mechanism and other data via another).

A second production is typically an off-line production. We can think of a Hollywood movie, but it can also be a show of somebody having a race through a jungle. Such a production may be shot with other optimal cameras, e.g. steadicam 211 and drone 210. We again assume that the camera feeds (which may be raw, or already converted to some HDR production format like HLG) are stored somewhere on network 212, for later processing. In such a production we may in the last months of production have some human color grader use grading equipment 213 to determine the optimal luminances (or relative brightnesses in case of HLG production and coding) of the master grading. Then the video may be uploaded to some internet-based video service 251. For professional video distribution this may be e.g. Netflix.

A third example is consumer video production. Here the user will have e.g. when making a vlog a ring lighter 221, and will capture via a mobile phone 220, but (s)he may also be capturing in some exterior location without supplementary lighting. S(h)e will typically also upload to the internet, but now maybe to YouTube, or TikTok, etc.

In case of reception via the internet, the display 263 sill be connected via a router 262 (more complicated setups like in-house Wi-Fi and the like are not shown in this mere elucidation).

So it can be seen that today, various kinds of video, in various technical codings, can be generated and communicated in various manners.

If HDR had been purely developed by computer technologists, it would be (but for the above aspects) still reasonably straightforward. In the computer world one looks at the luma code simply as some number, i.e. not necessarily optimized for any transmission standard, but merely for coding a corresponding brightness (relative), or luminance (absolute). And three e.g. 8 bit or 10 bit numbers specify fully the color of a 3-primary additive color system, e.g. non-linear R′G′B′, or YCbCr which can be calculated from R′G′B′ by applying a fixed matrix, of which the 9 constant coefficients depend on the primaries (e.g. the EBU primaries describing a standard set of CRT phosphors). The luminance channel, coded as a luma Y, behaves like on of the non-linear red, green and blue components, and is supplemented with color difference a.k.a. chrominance coordinates Cb and Cr.

In a computer representation (or when merely representing amounts of silver measured from a scan of a wet photography image), 0 would code for the blackest black. And 255 respectively 1023 for the brightest possible white.

Not so in broadcast technology, which is elucidated with FIG. 3.

The concept of narrow range (a.k.a. legal range LEG_RA) coding is, or rather has become, somewhat confusing in the era of HDR video coding. Together with so-called Full Range FU_RA (which in fact is not using the full range either, but is extended compared to narrow range), it is one of the two allowed coding modes for broadcasted video.

The concept stems from historical reasons when the analog (NTSC, or PAL or SECAM) voltage video signals got digitized. The white voltage was supposed to be 700 mV, but already due to overflow in analog circuits like filters, the voltage could extend “somewhat” above 700 mV. On the black end the main mechanism for underflow would be noise.

One can wonder whether (also given visual relevance) in a digital era one should not simply clip all values above 700 mV to a digital maximal value, e.g. the 1023 value of 10 bit codecs.

In the broadcast world, one chose to mix digital values which were meant to contain special codes, with values which contain codified values representing pixel brightnesses. In the analog world a low value would indicate e.g. a sync pulse. In full range the values below 4 and above 1019 should not be used for coding video brightnesses. They are reserved for timing reference (and should not be misunderstood). In legal range, a much larger set of codes is not allowed, which is especially impressive for small word lengths such as 8 bit.

It is a somewhat ambiguous concept: to be legal, it is requested that there should be no valid, i.e. relevant, pixel brightness codes outside the legal range. But then, if there is absolutely nothing there, one might as well use the full range, if nothing can occur outside range (except maybe some reserved codes). Now somebody grading in the full range of the computer should mind carefully: do we keep all values within the range 64-940, or do we liberally grade, with “1.0” being some float number maximum (which in some situations can be overflowed even by itself), and then one can “scale” the values to fit within the narrow range. Even when getting some signal that was (for some reason) generated as full range, one could scale the 1019 to map to the narrow range upper luma NR_UL being for 10 bit 940, be it that this introduces further quantization errors.

The idea was that in these guard bands (headroom and footroom), there should not be absolutely nothing, but rather something of secondary importance only.

If one had some small amount of ringing due to a filter e.g., the receiver may elect to reduce it by using both values near to the upper value within the legal range, and some values slightly above. The same for noise. If one were to clip the noise values below the narrow range lower luma (NR_LL), i.e. below 64, one would get noise with different statistics, i.e. no longer Gaussian as was the original e.g. thermal noise. If one uses an averaging filter, one would get a somewhat different noise reduced value. Whether that is really significant for viewing under a viewing conditions where one cannot see the blacks very well anyway, can be debated, but nonetheless the signal was defined as such.

In the HDR era the significance of the asymmetrically optimized headroom and footroom becomes even less to the point, since now the visibility impact of those regions will depend on the luminance mapping.

Some people started re-interpreting the headroom and footroom as something which could be used for communicating useful image information, namely, one could extend the range of codeable brightnesses with some extra luma codes representing some extra luminances above respectively below the range of Rec. 709 i.e. LDR, yielding extra highlights and deep blacks. Extending a relatively low curvature EOTF like the one of Rec. 709, which has approximately a square root shape, would not yield so many extra luminances or brightnesses to make it really relevant. But modern EOTFs like PQ and HLG have a highly non-linear (at least partially logarithmic) shape, which means that a few extra codes could lead to a significant extension of codeable dynamic range (e.g. a real logarithm may code e.g. with 255 codes a decade per 50 codes, i.e. going from 200 to 250 codes could e.g. extend from 100, to 10× more being 1000, i.e. the last 50 codes gain 90% additional range). But then one may use a trick to convey that one e.g. does not communicate full-range normal LDR range, or even full-range HDR range, but extended narrow range. Ergo, the system then knows that 940 would be some “normally bright” white, and the higher codes would code something brighter.

This can cause problems in receiving systems which don't expect anything useful to occur above 940 in received narrow-range signals, and those receiving apparatuses may (e.g. if they don't perform ringing mitigation, or already do that differently), simply assume they can ignore everything in the illegal headroom and footroom. So if such a system does luminance re-grading, or relative brightness re-grading, it may assume that 940 would be the maximum brightness, i.e. 100%. And if it associates some luminance with that value, it would by definition assume that the coded pixels for 1000 nit have the narrow-range code of 940. But also, that there would be nothing else. Many luminance re-gradings, especially those down-grading to lower dynamic range, would map the highest luminance (or its luma when doing the processing correspondingly directly in the luma domain) in the input image to the highest luminance respectively luma in the output domain, e.g. Rec. 709-defined for an LDR output image. And there would be nothing expected above that (respectively below the narrow rang lower limit), ergo if there is, such systems can't handle those luma codes, not even incorrectly. We think a colorimetrically skilled person should sufficiently understand how one can map luminances with a software algorithm or corresponding ASIC processing circuit, being fed with images from some memory, e.g. pixel by pixel, however where interested he can find an example of the kind of processing one may want to do with HDR signals in our Single Layer HDR standard (ETSI TS 103 433-2 V 1.1.1 January 2018).

Note that FIG. 3 shows, for easily understanding the general picture of our approach, a simpler one of the possible narrow container definitions. Instead of just one narrower range in a larger range, one can also have multi-range e.g. dual narrow range systems, in which there is a narrowest range, and beyond that-typically though not exclusively at both ends-some further codes (which e.g. may be used for some applications, but in a manner not critical for other applications), and beyond that a second duo of headroom and footroom lumas, which is supposed to be used e.g. only for some overshoots and the like (e.g. to reduce compression artefacts from reduced bit-rate). And that largest (“full”) range could either end at the maximum and minimum code of the bit word (e.g. for internal representations in processing ICs or grading software), or have a few reserved codes (e.g. for SDI communication).

In formal terms, one can say that the narrow range is smaller than the full range, which extends from zero to a code maximum CM, which depends of the number of bits (a.k.a. word length) used for coding the lumas (ultimately, even if some codes are reserved). The equation is CM=power(2, N) −1, where N is the number of bits, e.g. values N=8, 10, and 12 being frequently used. If there is an additional reduced range, e.g. by having a secondary narrow range upper limit NR_UL2 in between (e.g. halfway) NR_UL and CM, one can in general use the below embodiments by substituting the NR_UL2 value in place of the NR_UL value, and similarly at the dark end. One may define container representations where only one of the two sides is extended or further sub-divided in additional range limits, not both.

FIGS. 4A and 4B show (although our presented techniques are also useful for other codecs, e.g. narrow-range coded absolute luminance codings) a HLG-to-LDR conversion system for which the present techniques are useful, and which is easy for elucidation to the skilled person.

HLG was originally presented as an automatically backwards compatible system, in that its coded image is already a directly displayable LDR image. I.e. the image will look good, if one just “pretends” it was a regular LDR image, rather than a luma representation of what was actually a HDR image. That would have great benefits for free: new HDR displays could decode to an HDR image using the new HDR technical insights, but already deployed televisions could just display the image (i.e. its YCbCr pixel codes) as usual. Despite the fact that one then must make several assumptions and limitations on the production of that luma signal (i.e. one cannot produce as freely as the above described absolute HDR codecs), the system with its simple rigidity has a number of shortcomings which do not make it a preferred backwards compatible system, as there are too many color errors. So HLG became only a way to code a HDR image (not so backwards compatible). E.g., it became a popular straight-from-camera coding for such cameras that have an increased capturing dynamic range (how exactly the camera creates the HLG image from its RAW capturing, given its technical camera specifics, may still be a variable of the camera manufacturer, but that approach was considered sufficient anyway).

One of the things that HLG conversion (of say a 1000 nit ML_C HDR master video) performs when directly using it to drive legacy LDR displays, is a fixed tone mapping (as an end-to-end automatic behavior). But that doesn't mean it is the tone mapping as desired.

FIG. 4A shows what happens if 1000 nit ML_C HDR video is coded as 10 bit lumas, with a HLG Opto-Electronic Transfer Function (we assume full range for the moment). On the horizontal (input) axis are normalized luminances, defined as L_n=L/1000, ergo 1.0 represents 1000 nit (initially, when doing the coding). On the vertical axis normalized lumas are shown, i.e. 1.0 represents 1023 in a 10 bit representation. On the same plot, we have added what happens when a “dumb” legacy display thinks those are normal SDR lumas. Ergo, it will decode according to substantially the inverse of the Rec 709 OETF, which lies closer to the 45 degree diagonal of the plot. This has an advantage that the resultant mapping (which happens kind of automatically, i.e. not formally as an actual tone mapping processing step) is a tone mapping, which works relatively well for that situation, but is not perfect for all kinds of video content. E.g., the producer of a sports program may not like it. E.g., during a soccer match the ball may be lying in a sunlit part of the stadium (and remember, it should show reasonable dark patches ideally), and half of the audience may be sitting in a shadowy area. Ergo, the producer may find that, at least on that day, the audience is shown maybe somewhat too dark, or conversely too bright. This can be cured by implementing a—e.g. often static i.e. fixed for all images—tone mapping according to his preference, of which an illustrative example is given in FIG. 4B.

When following the upwards, rightwards and downwards arrows on FIG. 4A, we see a relative brightening of the decoded and finally to be displayed normalized luminance from 0.1 to 0.3, which is indeed what one would expect from a tone mapping to lower dynamic range for the darker colors in the range. However, one should understand that the input range is normalized by 1000, but we have shown overlapped on the horizontal axis the final output range, of an SDR image to be displayed. Those normalized luminances should be multiplied by 100, to get the final (absolute) luminance to be displayed. So actually, in an absolute luminance representation, one maps from an input at the coding side (i.e. the election in the master HDR grading of the object in the image those pixels belong to) of 100 nit, to only 30 nit. Again, “in general” this is behavior one would like to see for a down-mapping, since one must make room in the more limited SDR range for ultrabright pixels in the HDR image (the soccer ball under strong illumination, or LEDs on a commercial board in the stadium). But there is nothing especially correct about the value 30. Depending on what the original object was, or even the original general sub-range of luminances around 100 nit, that output value may be considered sufficiently reasonable, or bad and needing further adjustment.

Typically (though not necessarily) an election of a HLG-to-SDR mapping curve (F_grad) may have a shape similar to our elucidation shape in FIG. 4B (though typically more rounded and not consisting of line segments with pointy angles). As we see, we consider the darker colors above some black too dark (because if the division by 3), and may want to make them brighter. Maybe the somewhat brighter colors are brightened even more as can be see by the higher slope of the third line segment (remember, the axis are in luma, and therefore somewhat logarithmic, with the horizontal axis showing full range HLG lumas, and the output axis 10 bit SDR, i.e. Rec 709-defined lumas (PRO_SDR)). The last (4^{th}) segment will typically have a lower slope, as it needs to squeeze in the ultra-bright colors of the master HDR image (one needs to make some sub-optimizations, and those colors are typically less critical, e.g. not the faces of the players, but some lamps and highlights in the stadium).

We have chosen the second segment to continue through the narrow range lower limit (which may for 10 bits e.g. be 64, and for 8 bits 16, but can also be a different value in both situations), which has some property that darker colors are darkened. One may use a further (1^{st}) line segment to map the deepest blacks (which should theoretically be irrelevant or even non-existing blacks, if one fully adheres to legal range, but they may exist in the input signal nonetheless, and then one may want to do some processing to them (rather than just clip or ignore them or something).

So, when a processing element, e.g. a dynamic range processing in a receiver, gets or expects a legal range signal as input, it would be typical that it maps (by re-mapping TCHRAMA) the legal range limits to its processing range (PROC_RA) limits. As shown on the right of FIG. 3. E.g., when performing normalized luma mapping, the narrow range upper limit (NR_UL) would be re-mapped to correspond to 1.0, and the narrow range lower limit (NR_LL) would be re-mapped to 0 (and the in-between values can be distributed in a linearly stretched manner). That could pose some problems when there are some overflow or underflow values outside of the narrow range in the input signal. The mapping may go to 1023 on the input axis of the luma mapping when in non-normalized 10 bit numbers, or to 255 for 8 bit lumas, etc. Out-of-range situations may occur e.g. because cameras can output values outside of the legal limits, and the broadcaster decides to do follow-up processing on those out-of-legal ranges. There may be a final conformization to legal range just before broadcasting the video signal onto the broadcasting medium, but the processing before that may occur in non-compliant legal range, i.e. with outlying values in the headroom and footroom.

### SUMMARY OF THE INVENTION

If the outside of narrow range values cannot be processed (e.g. because they would fall outside of the processing range, e.g. a normalized range 0 to 1.0), a solution would be a luma mapping apparatus (500), arranged to luma map a video image (IM_IN) comprising pixels of which input lumas (Y_leg) are mainly to be specified in a reduced range (RR) compared to a full range (FR) which full range stretches from zero to a code maximum (CM), which code maximum equals two to the power N, where N is a number of bits for representing the lumas, minus one, which reduced range is delimited by a narrow range lower limit (NR_LL) which is greater than zero, and a narrow range upper limit (NR_UL) which is smaller than the code maximum, wherein some of the input lumas of some of the pixels have values outside the reduced range;
wherein the apparatus comprises a range compressor (102), which maps the lumas to renormalized lumas (Y_norm) comprising mapping the narrow range lower limit (NR_LL) to a processing range lower limit (PR_LL), and mapping the narrow range upper limit (NR_UL) to a processing range upper limit (PR_UL), and mapping all values in between by a linear scaling;
wherein the apparatus comprises a luma mapping circuit (103) arranged to map the renormalized lumas (Y_norm) to remapped lumas (Y_RM) by applying a fixed or configurable luma mapping function to the renormalized lumas;
characterized in that the apparatus comprises a pre-mapper (101) which is arranged to map luma values below a fixed or configurable inflection point (IFP) to values above the inflection point by a mirroring operation, and is arranged to output a sign bit having a first value (which indicates “negative original”, i.e. below IFP, which may as actual bit value e.g. be coded as 1, all non-mirrored lumas corresponding to the other bit value 0, or vice versa) for pixel lumas that have been mirrored, and a post-mapper (104) which re-mirrors such pixels for which the sign bit is “negative” around the inflection point (i.e. has the first value set, which only occurs for mirrored lumas, the non-mirrored lumas getting the other value).

Mainly to be specified is to be interpreted in-line with the pre-established technical purpose of the narrow range in the (e.g. broadcast television) luma container. Ergo, this means that the relevant grey values and colors should be specified within the narrow range, and only incidentally there should be some (insignificant) values outside the range, e.g. some ringing overflow of an electronic component, or processing, or some noise added to the system bringing at least a few pixel values below the narrow range lower limit, i.e. below e.g. 64 for 10 bit codings, or somewhat above the narrow range upper limit. But that is not typically intentionally specified by the creator of the video. More specifically, the distinction between where all specified color should be, inside the narrow range, is to be interpreted in that the video creator should create his narrow range container specification of the lumas (or in general color components) expecting that a typical display will clip away everything above NR_UL before displaying (i.e. display everything brighter as some maximum displayed white), and clip everything below NR_LL to minimum displayed black. The display could be doing some processing on the outside range values, such as noise diminution, before doing this display re-normalization. So the majority of the pixel values will have been specified to fall inside that narrow range.

By doing the mapping the values can be given a reasonable processing, even within the processing range, e.g. guaranteeing such a good noise diminishing.

The value of the inflection point may typically be set to the narrow range lower limit, i.e. e.g. 64.

Advantageously the luma mapping apparatus further comprising a control interface to set a luma value of the inflection point, e.g. 64. This enables the system to pre-identify which type of narrow range container coding occurs as input, in ecosystems which do not apply a single value. E.g., for higher bit luma words this value may be set higher (e.g. 2× higher for each additional luma coding bit), or for multiple sub-range containers the apparatus can set, e.g. by automatically identifying metadata, or as a user setting etc., the most appropriate value.

An advanced embodiment may have the pre-mapper (101) arranged to handle the lumas lower than the inflection point (IFP) as at least two segments, wherein the first segment (SEG_1) contains lumas which are higher than a first lower luma (Yls1), and the second segment (SEG_2) contains lumas which are lower than the first lower luma (Yls1), and is arranged to map lumas in the second segment above a projection segmentation point (P_Yls1) which is a mirroring around the inflection point of the first lower luma in a compressed manner by scaling a distance between a point of mapping (pmap) of any point in the second segment and the projection segmentation point by a ratio depending on an angle of the first segment and an angle of the second segment.

This is useful to handle intended luma mappings for which a shape of the luma mapping function below the inflection point is not linear, or approximatable with a single linear segment.

Alternatively, when doing the mirroring identically for all lumas below the inflection point (i.e. irrespective of the shape of the to be applied luma mapping function), the post-mapper (103) is arranged to identify a projection segmentation point (P_Yls1) which is a mirroring around the inflection point of a first lower luma (Yls1) which is a lowest limit luma of a first segment of lumas below the inflection point, and arranged to map lumas which are higher than the projection segmentation point to a position below the inflection point by an equation which involves a ratio of two distances, firstly a numerator being a distance between a point where the luma mapped value of a mapping of any input luma around the inflection point is located as re-mapped luma (Y_RM) to the projection segmentation point (P_Yls1), and secondly as a denominator a distance between a reference value (cvm) of the re-mapped luma values and the projection segmentation point (P_Yls1).

The various embodiment techniques can also be realized as a method of luma mapping a video image (IM_IN) comprising pixels of which input lumas (Y_leg) are mainly to be specified in a reduced range (RR) compared to a full range (FR) which full range stretches from zero to a code maximum (CM), which code maximum equals two to the power N, where N is a number of bits for representing the lumas, minus one, which reduced range is delimited by a narrow range lower limit (NR_LL) which is greater than zero, and a narrow range upper limit (NR_UL) which is smaller than the code maximum, wherein some of the input lumas of some of the pixels have values outside the reduced range;
the method performing a range compression, which maps the lumas to renormalized lumas (Y_norm) comprising mapping the narrow range lower limit (NR_LL) to a processing range lower limit (PR_LL), and mapping the narrow range upper limit (NR_UL) to a processing range upper limit (PR_UL), and mapping all values in between by a linear scaling;
the method subsequently performing a luma mapping arranged to map the renormalized lumas (Y_norm) to remapped lumas (Y_RM) by applying a fixed or configurable luma mapping function to the renormalized lumas;
characterized in that the method performs a pre-mapping prior to the range compression, which is arranged to map luma values below a fixed or configurable inflection point (IFP) to values above the inflection point by a mirroring operation, and is arranged to output a “negative” sign bits for pixel lumas that have been mirrored,
and performs a post-mapping which re-mirrors the remapped lumas of such pixels for which the sign bit is “negative” (e. g set to s=0, for pixel (0,0)) around the inflection point, back below the inflection point.

### BRIEF DESCRIPTION OF THE DRAWINGS

These and other aspects of the method and apparatus according to the invention will be apparent from and elucidated with reference to the implementations and embodiments described hereinafter, and with reference to the accompanying drawings, which serve merely as non-limiting specific illustrations exemplifying the more general concepts, and in which dashes are used to indicate that a component is optional, non-dashed components not necessarily being essential. Dashes can also be used for indicating that elements, which are explained to be essential, but hidden in the interior of an object, or for intangible things such as e.g. selections of objects/regions.

In the drawings:

FIG. 1 schematically illustrates the various possibilities of creating HDR images (and an SDR image), by showing luminance mappings of image object luminances along various possible HDR luminance ranges (i.e. dynamic ranges);

FIG. 2 schematically illustrates a few typical current video creation, communication and usage scenarios, in which the below techniques may be used;

FIG. 3 shows how some of the video coding technologies (sub-fields/markets) employ so-called narrow-range coding when putting the luma codes in a container (to be communicated e.g. by broadcasting), and some issues when mapping to a secondary range, e.g. a processing range for doing image processing, such as luma mapping for dynamic range conversion;

FIGS. 4A and 4B show issues when using a HLG coded HDR video as a SDR signal for legacy LDR displays, and how the non-ideal direct displaying can be improved by using an image improvement luma mapping (FIG. 4B);

FIG. 5 shows schematically a possible hardware realization of an apparatus according to the principles of the present teachings;

FIG. 6 shows the processing principles of some techniques to do the mirror mappings of the pre-mapper and post-mapper according to the presented innovations; and

FIG. 7 shows how the mirroring can be performed on the (individual) RGB components.

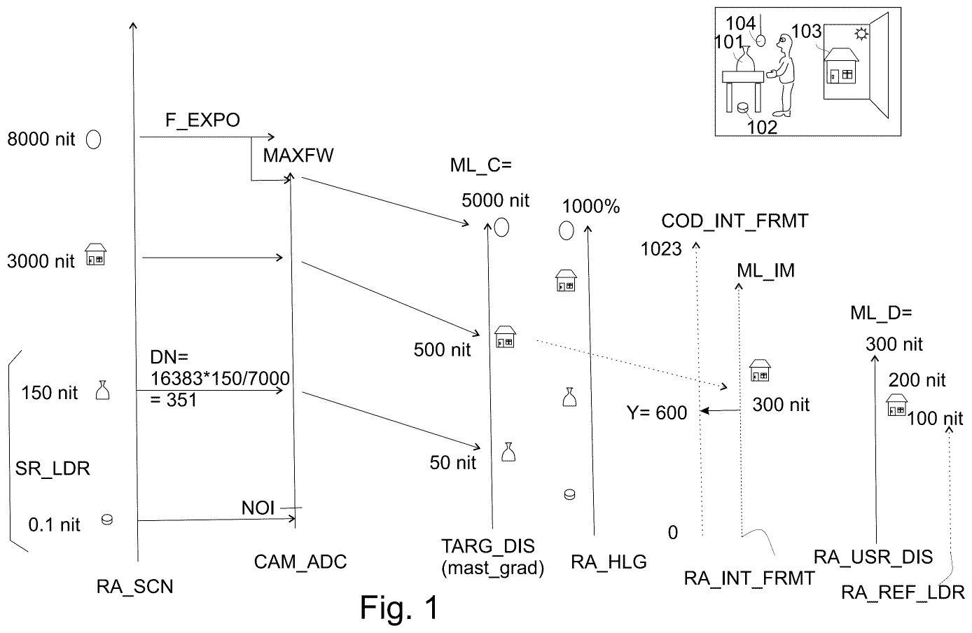

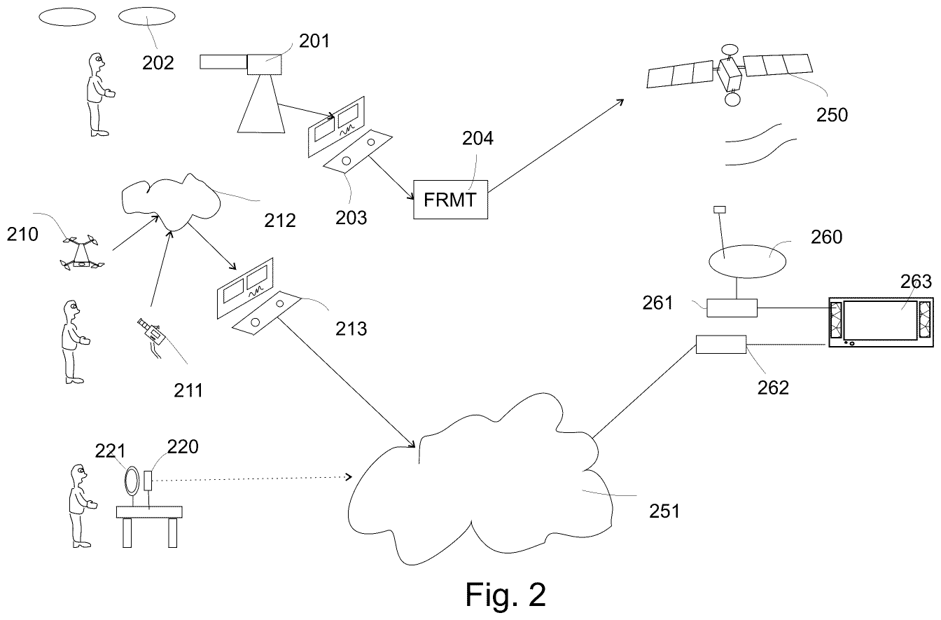

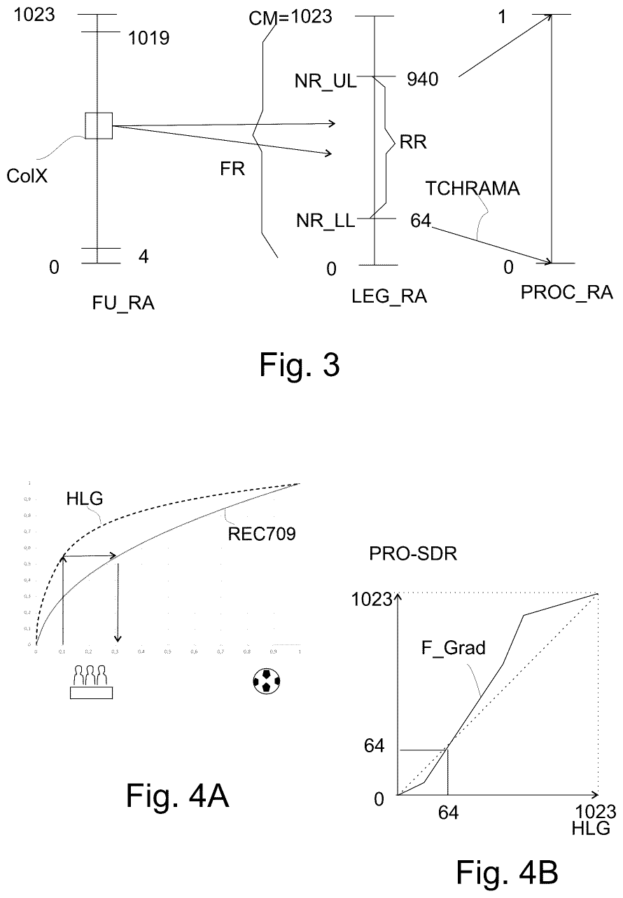

### DETAILED DESCRIPTION OF THE DRAWINGS

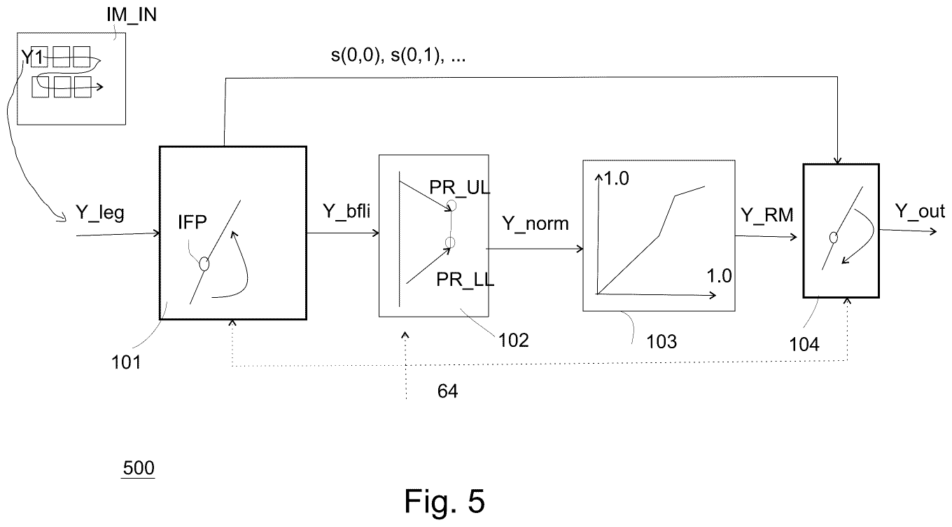

FIG. 5 elucidates in general what an apparatus for performing the present embodiments may look like. The luma mapper will process input pixel lumas one by one, in a sequence from a scan through the input image IM_IN (e.g. inputting as current Y_leg a first luma Y1 in the image of a first pixel, etc.) Compared to the basic concept of range renormalization (e.g. typically to a processing range running from processing range lower limit PR_LL to processing range upper limit PR_UL, which for elucidation but without limitation we give values equal to 0 and 1) and thereafter luma mapping (only on those lumas which would have fallen in the narrow range used by the range compressor (102)), the new circuit units according to the present technical insights are shown as thicker rectangles.

Note that when processing lumas (by luma mapper 103), e.g. normalized to 1.0 lumas, it does not matter whether they represent relative brightnesses (i.e. percentages of some non-numerically specified maximum), or actual luminance values, e.g. luminances to be displayed on a display, provided that display has a displayable luminance range greater than or equal to the range of luminances prescribed (coded) in the video.

The luma mapping function may advantageously be constrained to use the same narrow range lower limit in the input (e.g. HLG) and output (e.g. Rec. 709 SDR) luma range, i.e. the function would map e.g. 64 onto 64, whatever the shape around this.

If the mapping is non-linear, one may want to approximate it with a linear function, or with a connected set of linear segments. This linearization is only important in the region around the inflection point, i.e. below 64, and to where the darkest black lumas will mirror, i.e. e.g. below 128. For a 1023 luma function, it is not a major restriction if the function shape is linear through the inflection point up to luma 128, and above 128 it may still have any shape as desired (e.g. to keep some contrast in the sunlit houses outside the door opening, yet strongly compress the colors in the light bulb). For some situations one may want to use a double segment approach for the darkest colors below the inflection point IFP (more segments may in many applications—for which this invention is useful—not be necessary).

The projection of colors above the inflection point, i.e. by the premapper 101, to bring them in-range of what will later be luma mappable, can be formulated as follows:
For any luma Yx (below IFP), if it has a value (e.g. on the horizontal axis) Yx=64−D, it will map to 64+D. One can also show this corresponds to the equation Y_bfli=128−Yx, where Y_bfli is the inflected luma in case the original luma Y_leg was below the luma of the inflection point, and is equal to Y_leg otherwise. The pre-mapper also outputs for each mirrored luma a sign bit. An easy manner to implement this in practice (though other possibilities exist like e.g. storing a bit together with a pixel position coding, or a list s(0,0), s(0,1), . . . of all signs being “+1” respectively “−1”, or 0 respectively 1), is to send each bit for a pixel being processed directly to the post-processor (possibly via a delay element accounting for the same amount of time as the processing delay in 102 and 103). It depends on whether in practice this apparatus is manufactured as e.g. an all-ASIC color processing pipeline circuit, or whether only the element 103, or 102 and 103 are on a processing circuit, and the other units are management software around the circuit (firmware). The (re)normalized lumas (Y_norm) output from the range compressor become remapped lumas (Y_RM) after luma mapping. Note that although we have shown a simple luma mapper in the elucidation of the new technical concepts, the actual mapping may be more complex. E.g., one may perform the mapping in another luma representation. E.g. one may first transform the lumas Y_norm to perceptually uniformized lumas (Y_perc), then perform a luma mapping in perceptually uniformized luma domain (this will have a different shape luma mapping function, which will ultimately have the same result, ergo, the skilled person can calculate the shape of the perceptually uniformized luma domain function when knowing the ultimately to be applied luma mapping function), and then go back to the output luma domain as desired, in the elucidating example Rec. 709 lumas.

And finally after re-mirroring by the post-processor they become output lumas Y_out (those may be ready for e.g. formatting as a broadcast signal backwards compatible with legacy LDR displays, or in a display send as LDR image to e.g. a panel driver, and/or be further processed etc. The value of the inflection point (e.g. 64) may be set by external circuitry, and loaded in the various units which need it.

For a single line segment, the post-mapper 103 will re-mirror the value of the point after luma mapping, with the same equation (but inverse, downwards to darker than IFP). Note that in practice also the range compressor (102) may (although we have shown it for the teaching as 1 mapping) consist of several range mappings, e.g. to an intermediate range (e.g. a full range) before mapping to the processing range.

For dual-segment luma mappings, one can elect to implement the mirroring adjustment (as a scaled/compressed mirroring) either in the post-processor or the pre-processor, leaving the other one apply a standard mirroring (128−Yx).

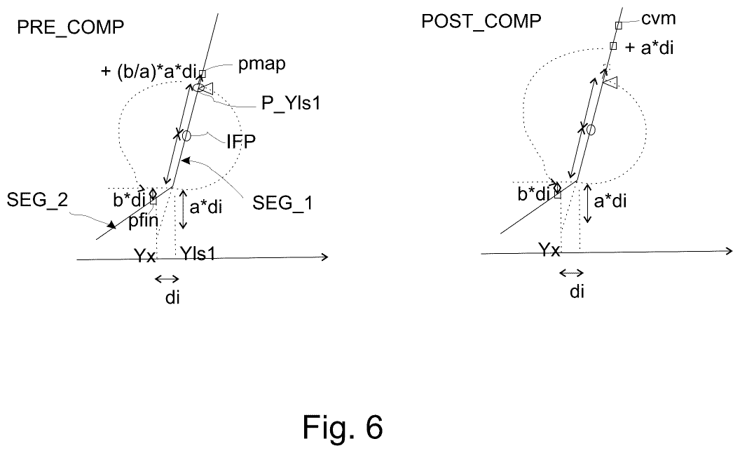

This is shown in FIG. 6, on the left the pre-mapping principle, and on the right the post-mapping principle.

Starting on the left graph (showing the luma mapping function F-Grad in detail around the inflection point) lumas in the first segment (SEG_1) below IFP will be mirrored normally (i.e. without slope adjustment compression), i.e. with equation 128−Yx, or similar for other values of the inflection point. Note that there may not actually be values present in the second segment, below Yls1, in some video, but the curve behavior may be prescribed, and one may load it in the luma mapping apparatus anyway (then one doesn't need to know what dark values are present, one just luma maps whatever comes in).

We see that, if we were processing with the intended luma mapping function (i.e. the guiding one, in a scenario where one could simply map below IFP lumas) luma Yx will not fall at a vertical distance a*di below the lower endpoint of the first segment, but only at a distance b*di. Knowing that the mirroring of the lower endpoint of the first segment ends at P_Yls1, we can map to a compressed mirrored position (pmap), compressed by exactly the ratio of the angles (or slopes) of the two line segments, i.e. b/a. Doing a normal mirroring back around IFP will then bring the pmap point to the correct position (pfin), and that will yield for all pixels in the second segment (SEG_2) correctly. (di is the distance of any point from the lowest point of the first segment, as a horizontal luma value distance, for understanding the principle).

On the right side we see that the pre-mapper can map all points initially in the same manner (by a normal, non-compressor up-mirroring above IFP), but then the post-mapper will need to correctly re-mirror, taking account of the correct scaling for the second segment.

One embodiment code performing this is the following:
% pre-mapping
% convert “negative” values (<64) to positive values, while keeping sign bits
% input: hlgcv[] contains the 10 bit extended narrow range HLG code values;
% cvm contains the highest HLG code value that can be used, i.e.
% cvm 32 min(128,“highest R=G=B HLG code value for which R=G=B gamma code value<=128”)
if (hlgcv[i]<64)
sb[i]=1; % negative
else
sb[i]=0; % positive
end
if (hlgcv[i]>31) & hlgcv[i]<64) % code values 32 . . . 63
hlgcv[i)=128-hlgcv[i]; % mirrored map to values 65 . . . 96
end
if (hlgcv[i]<=31) % code values 0 . . . 31
hlgcv[i]=97+(31 hlgcv[i])*(cvm 97)/31; % mirrored map to values 97 . . . cvm
end
% output: hlgcv[] contains only “positive” HLG code values>=64
% sb[ ] stores the sign bits indicating which values were originally “negative”<64

The value of cvm may be e.g. 113 (it may depend on what luma mapping will be done, such as the amount of boosting of the darkest lumas).

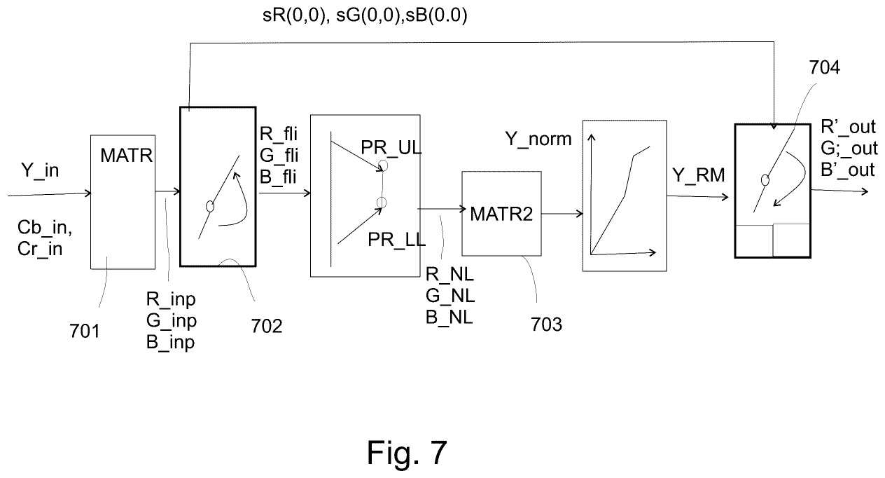

FIG. 7 shows a preferred embodiment. It is not required that the mirroring actually happens on a luma component of the pixel color. It may be advantageous to do it on the three RGB components (which will typically be non-linear components R′G′B′ according to some EOTF). Normally the pixel colors would come in as Y_in, Cb_in, Cr_in, so a first matrixing circuit 701 will convert them to RGB, yielding input R_inp, G_inp, and B_inp. The coefficients of this matrix are fixed for an elected set of RGB primaries, and the skilled person of video tech is well aware how to do it, or its inverse. Now each of the three components can be flipped, separately, by similarly working pre-mapper 702. It will normally not have differential inflection points for the three components, but rather the three mappings will use the same value, however, the three components can have different sign bits. It can happen, e.g. under gamut overflows, that e.g. one of the components is negative (or more precisely below the inflection point) and the other two are okay (within processing range automatically). So, for one (or several) pixel(s) a set of three sign bits sR(0,0), sG(0,0), sB(0,0) will be communicated to the re-mirroring post-mapper 704.

We have (without intending to be limited) shown again a dynamic range mapping processing which happens on lumas. Thereto the mirrored in-processing-range red, green and blue component (R_NL, G_NL, B_NL) having been obtained by narrow range mapping (R_fli, G_fli, B_fli) are inverse matrixed by matrix circuit 703 to become YCbCr again. But other embodiments may do the luminance processing directly on the RGB components, preferably keeping the ratios R/G, R/B, and G/B constant, i.e. R_NL/G_NL=R_RM/G_RM, etc., where R_RM and G_RM are the re-mapped red and blue color component similar to Y_RM as previously explained. Since three are now three sign bits which are potentially different (some +1, and some −1 for a pixel), the post-mapper 704 will in general also be somewhat different, which has been shown with its internal sub-circuits (internal rectangles). Typically it will first do again a matrixing from (Y_RM, Cb, Cr) to RGB, and then mirror the RGB components which need it according to their sign bit, so e.g. the red component of the first pixel if sR(0,0)=“−1”, but not the green component if sG(0,0)=“1”. In this example we have also elucidated direct RGB output, e.g. to drive a display, but further color representation conversions may be present in other embodiments, but need not be detailed for this technology's elucidation.

The algorithmic components disclosed in this text may (entirely or in part) be realized in practice as hardware (e.g. parts of an application specific integrated circuit) or as software running on a special digital signal processor, or a generic processor, etc. The images may be temporarily or for long term stored in various memories, in the vicinity of the processor(s) or remotely accessible e.g. over the internet.

It should be understandable to the skilled person from our presentation which components may be optional improvements and can be realized in combination with other components, and how (optional) steps of methods correspond to respective means of apparatuses, and vice versa. Some combinations will be taught by splitting the general teachings to partial teachings regarding one or more of the parts. The word “apparatus” in this application is used in its broadest sense, namely a group of means allowing the realization of a particular objective, and can hence e.g. be (a small circuit part of) an IC, or a dedicated appliance (such as an appliance with a display), or part of a networked system, etc. “Arrangement” is also intended to be used in the broadest sense, so it may comprise inter alia a single apparatus, a part of an apparatus, a collection of (parts of) cooperating apparatuses, etc.

The computer program product denotation should be understood to encompass any physical realization of a collection of commands enabling a generic or special purpose processor, after a series of loading steps (which may include intermediate conversion steps, such as translation to an intermediate language, and a final processor language) to enter the commands into the processor, and to execute any of the characteristic functions of an invention. In particular, the computer program product may be realized as data on a carrier such as e.g. a disk or tape, data present in a memory, data travelling via a network connection—wired or wireless—. Apart from program code, characteristic data required for the program may also be embodied as a computer program product. Some of the technologies may be encompassed in signals, typically control signals for controlling one or more technical behaviors of e.g. a receiving apparatus, such as a television. Some circuits may be reconfigurable, and temporarily configured for particular processing by software.

Some of the steps required for the operation of the method may be already present in the functionality of the processor instead of described in the computer program product, such as data input and output steps.

It should be noted that the above-mentioned embodiments illustrate rather than limit the invention. Where the skilled person can easily realize a mapping of the presented examples to other regions of the claims, we have for conciseness not mentioned all these options in-depth. Apart from combinations of elements of the invention as combined in the claims, other combinations of the elements are possible. Any combination of elements can in practice be realized in a single dedicated element, or split elements.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements, nor the presence of other elements.

1. A luma mapping apparatus comprising: a range compressor circuit,
wherein the ranger compressor circuit is arranged to map input lumas to renormalized lumas, wherein a video image comprises pixels,
wherein the pixels have the input lumas,
wherein a first portion of the input lumas are specified in a reduced range,
wherein the reduced range is a portion of a full range,
wherein the full range stretches from zero to a code maximum,
wherein the code maximum equals two to the power N,
wherein N is a number of bits for representing the input lumas minus one,
wherein the reduced range is delimited by a narrow range lower limit and a narrow range upper limit,
wherein the narrow range lower limit is greater than zero,
wherein the narrow range upper limit is smaller than the code maximum,
wherein a second portion of the input lumas values are outside the reduced range,
wherein the mapping comprises mapping the narrow range lower limit to a processing range lower limit, mapping the narrow range upper limit to a processing range upper limit and mapping all values between the narrow range lower limit and the narrow range upper limit by a linear scaling;
a luma mapping circuit, wherein the luma mapping circuit is arranged to map the renormalized lumas to remapped lumas by applying a luma mapping function to the renormalized lumas; and
a pre-mapper circuit,
wherein the pre-mapper circuit is arranged to map luma values below an inflection point to values above the inflection point by a mirroring operation,
wherein the pre-mapper circuit is arranged to output a sign bit for pixel lumas that have been mirrored, wherein the sign bit equals a first value; and
a post-mapper circuit, wherein the post-mapper circuit which re-mirrors pixels for which the sign bit equals the first value in close proximity to the inflection point.

2. The apparatus as claimed in claim 1, further comprising a control interface, wherein the control interface is arranged to set a luma value of the inflection point.

3. The luma mapping apparatus as claimed in claim 1,
wherein the pre-mapper circuit is arranged to process lumas lower than the inflection point in at least two segments,
wherein the first segment comprises lumas which are higher than a first lower luma, wherein the second segment comprises lumas which are lower than the first lower luma,
wherein the pre-mapper circuit is arranged to map lumas in the second segment above a projection segmentation point,
wherein the projection segmentation point is mirrored around the inflection point of the first lower luma,
wherein the mirroring is compressed by scaling a distance between a point of mapping of any point in the second segment and the projection segmentation point by a ratio,
wherein the ratio is based on an angle of the first segment and an angle of the second segment.

4. The apparatus as claimed in claim 1,
wherein the post-mapper circuit is arranged to identify a projection segmentation point,
wherein the projection segmentation point is mirrored around the inflection point of a first lower luma,
wherein the projection first lower luma is a lowest limit luma of a first segment of lumas below the inflection point,
wherein the post-mapper circuit is arranged to map lumas which are higher than the projection segmentation point to a position below the inflection point based on an equation,
wherein the equation has a numeration and a denominator,
wherein the numerator is a distance between a point and a projection segmentation point,
wherein the point is the luma mapped value of a mapping of any input luma around the inflection point located as re-mapped luma,
wherein the denominator a distance between a reference value of the re-mapped luma values and the projection segmentation point.

5. A method comprising:
mapping input lumas to renormalized lumas, wherein a video image comprises pixels,
wherein the pixels have the input lumas,
wherein a first portion of the input lumas are specified in a reduced range,
wherein the reduced range is a portion of a full range,
wherein the full range stretches from zero to a code maximum,
wherein the code maximum equals two to the power N,
wherein N is a number of bits for representing the input lumas minus one,
wherein the reduced range is delimited by a narrow range lower limit and a narrow range upper limit,
wherein the narrow range lower limit is greater than zero,
wherein the narrow range upper limit is smaller than the code maximum,
wherein a second portion of the input lumas values are outside the reduced range,
wherein the mapping comprises mapping the narrow range lower limit to a processing range lower limit, mapping the narrow range upper limit to a processing range upper limit and mapping all values between the narrow range lower limit and the narrow range upper limit by a linear scaling;
luma mapping the renormalized lumas to remapped lumas by applying a luma mapping function to the renormalized lumas; and
pre-mapping by mapping luma values below an inflection point to values above the inflection point by a mirroring operation,
wherein the pre-mapping comprises outputting a sign bit for pixel lumas that have been mirrored, wherein the sign bit equals a first value; and
post-mapping a portion of the pixels, wherein the post-mapping re-mirrors pixels for which the sign bit equals the first value in close proximity to the inflection point.

6. The method as claimed in claim 5, further comprising setting a luma value of the inflection point.

7. The method as claimed in claim 5, further comprising:
processing lumas lower than the inflection point in at least two segments,
wherein the first segment comprises lumas which are higher than a first lower luma,
wherein the second segment comprises lumas which are lower than the first lower luma; and
mapping lumas in the second segment above a projection segmentation point,
wherein the projection segmentation point is mirrored around the inflection point of the first lower luma,
wherein the mirroring is compressed by scaling a distance between a point of mapping of any point in the second segment and the projection segmentation point by a ratio,
wherein the ratio is based on an angle of the first segment and an angle of the second segment.

8. The method as claimed in claim 5, further comprising:
identifying a projection segmentation point,
wherein the projection segmentation point is mirrored around the inflection point of a first lower luma,
wherein the projection first lower luma is a lowest limit luma of a first segment of lumas below the inflection point; and
mapping lumas which are higher than the projection segmentation point to a position below the inflection point based on an equation,
wherein the equation has a numeration and a denominator,
wherein the numerator is a distance between a point and a projection segmentation point,
wherein the point is the luma mapped value of a mapping of any input luma around the inflection point located as re-mapped luma,
wherein the denominator a distance between a reference value of the re-mapped luma values and the projection segmentation point.
